(19) United States
(12) Patent Application Publication
(10) Pub. No.: US 2006/0278781 A1
(43) Pub. Date: Dec. 14, 2006

(54) Medical device mount

(75) Inventors: Ronald A. Homra, Jackson, TN (US); Theodore E. Nelson, Jackson, TN (US); Ernest E. Wilson, Jackson, TN (US)

Correspondence Address: Larry W. McKenzie;Walker, McKenzie & Walker, P.C., Suite 434, 6363 Poplar Avenue, Memphis, TN, 38119-4896, US

(73) Assignee: Mar-Lin Medical, LLC., Jackson, TN (US)

(21) Appl. No.: 11/401,107

(22) Filed: Apr. 10, 2006

Related U.S. Application Data
(63) Continuation-in-part of application No. 29/216,947, filed on Nov. 11, 2004.

(51) Int. Cl. E04G 5/06; A47G 29/00; E04G 3/00; F21V 21/00; F21V 35/00; A47B 96/06; A47K 1/00

(52) U.S. Cl. 248/220.21

(57) ABSTRACT

A mount for mounting a medical device to a support member. The mount includes a body member having a face to which a medical device can be attached, having a support member receiving first slot, and having a support member receiving second slot; and a fastener for fastening the body member to a support member.

### CROSS REFERENCE TO RELATED APPLICATION

This application is a continuation-in-part of application Ser. No. 29/216,947, filed Nov. 11, 2004, entitled “THREE-WAY CLAMP BODY”, now pending.

### BACKGROUND OF THE INVENTION

1. Field of the Invention

The present invention relates, in general, to mount for mounting a medical device (e.g., an oral suction device holder) to any of a multiple of support members (e.g., an operating room bed, and I.V. pole, a ventilator, or a wall surface or portion).

2. Background Art

Various medical devices such as suction devices and the like are commonly used by anesthesiologists, surgeons, and other health care professionals for performing various procedures such as suctioning a patient's bodily fluid and the like from the patient's oral cavity and/or surgical field or site, etc., during operations, while the patient is in intensive care, etc. A typical suction device commonly includes a relative rigid suction tube having a distal end with one or more apertures therein for being inserted into a patient's mouth and/or surgical site to suction the oral cavity and/or surgical site during surgery, etc., and a proximal end for being attached to a vacuum source via an elongated, flexible hose. The proximal end of the suction tube preferably has a handle portion provided thereon or formed integrally therewith to allow an anesthesiologist, surgeon, or other health care professional to easily and accurately manipulate the suction tube. Such suction tubes are provided in sterile packages for use during a single operation, etc. Both oral suction devices and surgical site suction devices are sold by Sherwood Medical of St. Louis, Mo. 83103, as ARGYLE™ Yankauer Suction Tubes.

Holders for oral suction devices have been developed to improve patient care during operations and in intensive care units, etc. A serious problem with the use of such suction devices is what to do with the suction tube after it has been removed from its sterile packages and after its initial use. That is, after a suction tube is first used to suction a patient's oral cavity and/or surgical site, it's exterior surfaces will be covered with body fluid and/or blood, etc., from the patient's oral cavity and/or surgical site. Even if the suction tube is the disposable type, it is generally meant to be used throughout a single operation or procedure.

Homra, U.S. Pat. No. 5,915,963, issued Jun. 29, 1999; Homra, U.S. Pat. No. 5,927,974, issued Jul. 27, 1999; and Homra, U.S. Pat. No. 6,077,074, issued Jun. 20, 2000, all disclose means for holding oral suction devices during operations and the like to prevent or reduce the likelihood of contamination of the oral suction devices during operations and the like. These holding means typically include mounts for mounting to the rail an operating bed or the like.

Wright, U.S. Pat. No. 5,752,286, issued May 19, 1998, discloses a cleaning and storage system for a body cavity aspirator or suction tube. That cleaning and storage system includes a holder having a narrow mouth for receiving the distal end of the aspirator, cleaning fluid in the holder for facilitating cleaning of the distal end of the aspirator, and a wiper cap disposed over the mouth of the holder for wiping cleaning fluid off the aspirator when the distal end of the aspirator is removed from the holder.

None of these references, either singly or in combination, disclose or suggest the present invention.

### BRIEF SUMMARY OF THE INVENTION

The present invention provides a mount for mounting a medical device, especially an oral suction device holder, to a support member, and, more specifically, to any of a multiple of support members (e.g., an operating room bed, and I.V. pole, a ventilator, or a wall surface or portion).

The mount of the present invention includes a body member having a face to which a medical device can be attached, having a support member receiving first slot, and having a support member receiving second slot; and fasten means for fastening the body member to a support member.

### BRIEF DESCRIPTION OF THE SEVERAL VIEWS OF THE DRAWINGS

FIG. 1 is a perspective view of the medical device mount of the present invention taken from the front.

FIG. 2 is a perspective view of the medical device mount of the present invention taken from the rear.

FIG. 3 is a bottom plan view of the medical device mount of the present invention.

FIG. 4 is a sectional view substantially as taken on line 4-4 of FIG. 2.

FIG. 5 a perspective view of a wall support member of the medical device mount of the present invention.

FIG. 6 is a front elevational view of the wall support member of FIG. 5.

FIG. 7 is a side elevational view of the wall support member of FIG. 5.

FIG. 8 is a sectional view substantially as taken on line 8-8 of FIG. 6, showing the wall support member attached to a wall member.

FIG. 9 is a somewhat diagrammatic perspective view of the medical device mount of the present invention shown in combination with an I.V. pole and portions of an oral suction device holder.

FIG. 10 is a top plan view of the combination of FIG. 9.

FIG. 11 is a somewhat diagrammatic perspective view of the medical device mount of the present invention shown in combination with the rail of an operating bed and portions of an oral suction device holder.

FIG. 12 an end view of the combination of FIG. 11.

FIG. 13 is a somewhat diagrammatic perspective view of the medical device mount of the present invention shown in combination with a wall member and portions of an oral suction device holder.

FIG. 14 is a sectional view substantially as taken on line 14-14 of FIG. 13.

### DETAILED DESCRIPTION OF THE INVENTION

The medical device mount of the present invention is shown generally in the drawings and identified by the numeral 11. The mount 11 is designed for mounting a medical device 13 to a support member 15 such as an I.V. pole 17 or the like, a rail 19 of an operating bed or ventilator or the like, or a wall surface or portion 21 of an intensive care room or the like. The medical device 13 may be, for example, an oral suction device holder or a portion thereof, etc. Thus, for example, the medical device 13 may be a body member of a typical oral suction device holder such as the body member 61 or 62 disclosed at, for example, column 6, lines 58-67 and FIGS. 1 and 17 of Homra, U.S. Pat. No. 6,077,074, issued Jun. 20, 2000, which is fully incorporated herein by reference. A disposable pouch (not shown) is removably mounted to the body member 61 or 62 to hold the distal end of an oral suction device.

The mount 11 includes a body member 23 having a face 25 to which the medical device 13 can be attached, having a support member receiving first slot 27, and having a support member receiving second slot 29. The first slot 27 extends across the body member 23 in a first direction (e.g., normally substantially vertical), and is shaped to receive a pole such as a standard I.V. pole 17. The second slot 29 extends across the body member 23 in a second direction substantially transverse to the first direction (e.g., normally substantially horizontally), and is shaped to receive a rail such as a standard rail 19 of an operating bed or ventilator or the like.

The face 25 preferably has aperture 31 to which the medical device 13 can be attached by way of a screw 33 and washer 35 or the like. A series of projections 37 about the aperture 31 so that the medical device 13 can be rotated about the aperture 31 in a snap-like manner.

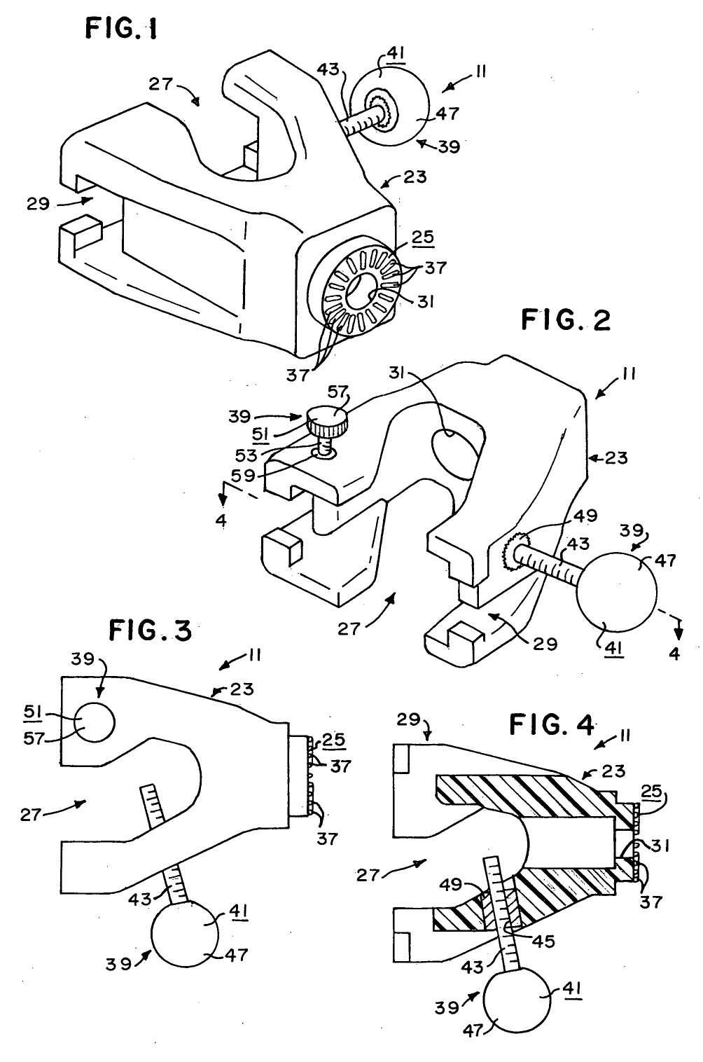

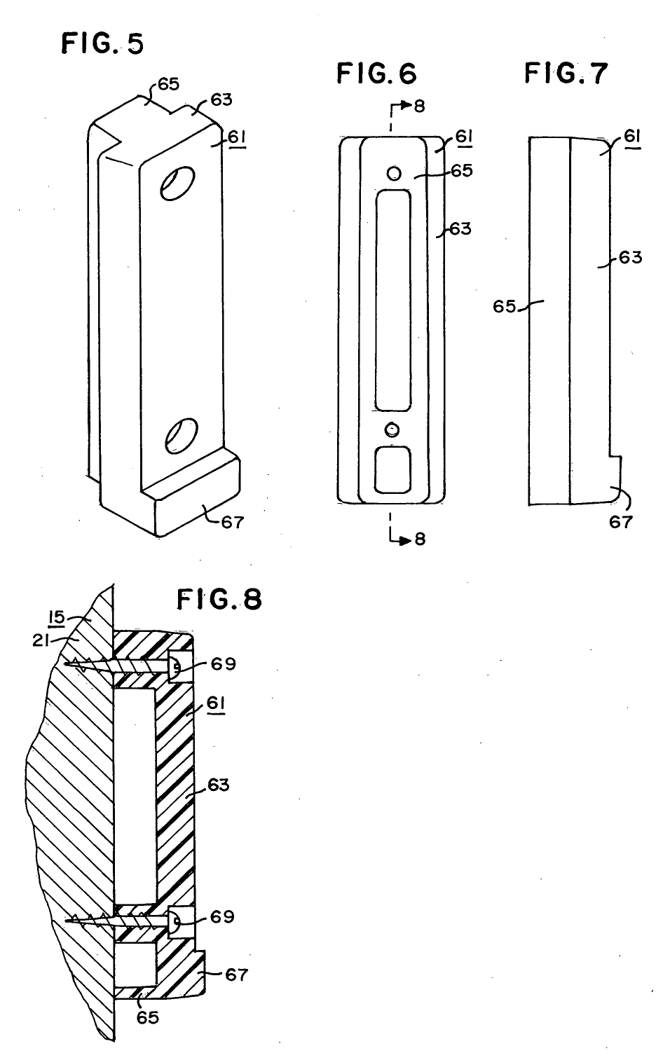

The body member 23 may be manufactured in various shapes and sizes and out of various materials. Preferably, the body member 23 is molded or otherwise constructed out of plastic or the like in the specific shape clearly shown in FIGS. 1-4.

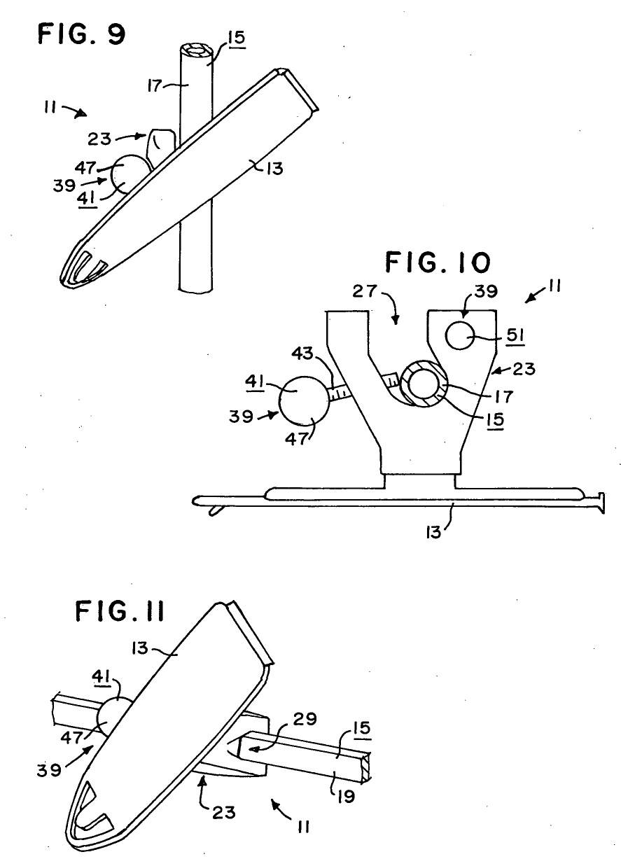

The mount 11 includes fasten means 39 for fastening the body member 23 to a support member 15. The fasten means 39 preferably includes a first screw member 41 for extending into the first slot 27 to fasten the body member 23 to a support member 15 extending through the first slot 27 (e.g., the I.V. pole 17 as shown in FIGS. 9 and 10). The first screw member 41 includes a threaded rod 43 that extends through a threaded aperture 45 in the body member 23 of the mount 11, and an enlarged head 47 or the like on the outer end of the rod 43 to allow the rod 43 to be rotated and screwed into or out of the aperture 45, etc., as will now be apparent to those skilled in the art. The aperture 45 may be formed in a metal insert 49 which is pressed into the body member 23 to strengthen the connection between the rod 43 and body member 23.

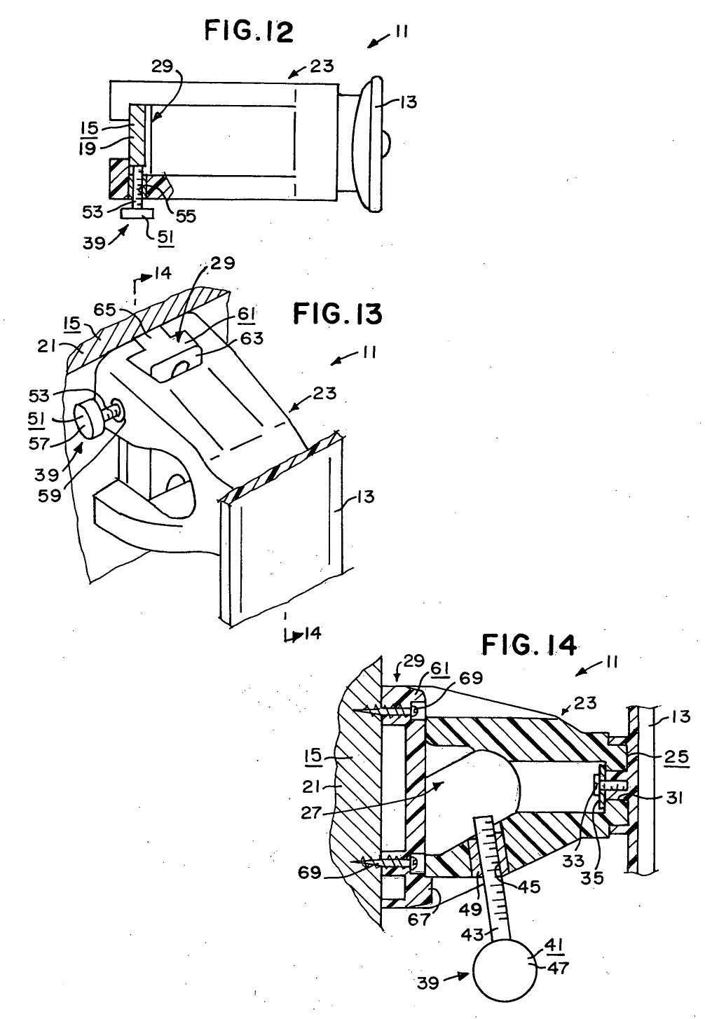

The fasten means 39 preferably includes a second screw member 51 for extending into the second slot 29 to fasten the body member 23 to a support member 15 extending through the second slot 29 (e.g., the operating bed or ventilator rail 19 shown in FIGS. 11 and 12. The second screw member 51 preferably includes a threaded rod 53 that extends through a threaded aperture 55 in the body member 23 of the mount 11, and an enlarged head 57 or the like on the outer end of the rod 53 to allow the rod 53 to be rotated and screwed into or out of the aperture 55, etc., as will now be apparent to those skilled in the art. The aperture 55 may be formed in a metal insert 59 which is pressed into the body member 23 to strengthen the connection between the rod 53 and body member 23.

The mount 11 preferably include a wall connector 61for being attached to a wall surface or portion 21 and for being received in the second slot 29 of the body member 23 to connect said body member 23 to the wall portion 21. The wall connector 61 preferably includes a rail 63, a spacer 65 for being positioned between the wall portion 21 and the rail 63, and a protuberance 67 extending outward from the rail 63 to act as a stop to prevent the body member 23 from sliding off the wall connector 61 (see FIG. 14). Screws 69 are preferably used to attach the wall connector 61 to the wall portion 21 with the rail 63 located in a generally vertical position and with the protuberance 67 located on the lower end of the rail 63.

The wall connector 61 may be manufactured in various shapes and sizes to coact with the body member 23, and out of various materials. Preferably, the wall connector 61 is molded or otherwise constructed out of plastic or the like in the specific shape clearly shown in FIGS. 58.

Although the present invention has been described and illustrated with respect to a preferred embodiment and a preferred use therefor, it is not to be so limited since modifications and changes can be made therein which are within the full intended scope of the invention.

1. A mount for mounting a medical device to a support member; said mount comprising:
(a) a body member having a face to which a medical device can be attached, having a support member receiving first slot, and having a support member receiving second slot; and
(b) fasten means for fastening said body member to a support member.

2. The mount of claim 1 in which said fasten means includes a screw member for extending into said first slot to fasten said body member to a support member extending through said first slot.

3. The mount of claim 1 in which said fasten means includes a screw member for extending into said second slot to fasten said body member to a support member extending through said second slot.

4. The mount of claim 1 in which is included a wall support member connector for being attached to a wall surface and for being received in said second slot of said body member to connect said body member to the wall surface.

5. The mount of claim 1 in which said first slot extends across said body member in a first direction, and in which said second slot extends across said body member in a second direction substantially transverse to said first direction.

6. A mount for mounting a medical device to a pole or a rail; said mount comprising:
(a) a body member having a face to which a medical device can be attached, having a pole receiving first slot extending across said body in a first direction, and having a rail receiving second slot extending across said body in a second direction substantially transverse to said first direction;
(b) a first screw member for extending into said pole receiving first slot and
(c) a second screw member for extending into said second rail receiving slot.
